(19) United States
(12) Patent Application Publication
(10) Pub. No.: US 2012/0039652 A1
(43) Pub. Date: Feb. 16, 2012

(54) Extendable Hand Lotion Applicator

(76) Inventor: Stacey Reed, Ranson, WV (US)

(21) Appl. No.: 13/198,110

(22) Filed: Aug. 4, 2011

Related U.S. Application Data
(60) Provisional application No. 61/372,301, filed on Aug. 10, 2010.

(51) Int. Cl. A45D 40/00; B05C 17/00

(52) U.S. Cl. 401/6; 401/261

(57) ABSTRACT

A device designed to assist with the convenient and easy application of suntan lotion to all areas of the body. The device comprises a lifelike, hand-shaped applicator that allows even and comfortable spreading of the lotion on a user's skin. Further, the applicator includes human-like features, such as wrinkles and nails, and has fingers capable of manipulation to provide a more human feeling. The device further comprises a handle with one or more hinges, allowing the device to be folded and stored in a small bag or purse. The device does not require disposable pads, and provides a user with a lotion applicator that eliminates straining or missed application regions such as the back and legs.

### CROSS REFERENCE TO RELATED APPLICATION

This application claims the benefit of U.S. Provisional Application No. 61/372,301 filed on Aug. 10, 2010, entitled “X-tend A Hand.”

### BACKGROUND OF THE INVENTION

1. Field of the Invention

The present invention relates to a lotion applicator. More specifically, the present invention relates to a collapsible and portable lotion applicator that does not require the use of disposable pads.

To protect skin from harsh sunlight, extreme cold or dry weather conditions, many consumers spread sun block, lotion, or other products on their body. Individuals may experience difficulty in providing sufficient coverage when applying these products independent of assistance. The center portion of one's back is considered one of the most difficult parts of the body to reach without assistance. When attempting to apply skin products to this area of the body, many consumers may strain their necks or backs, which can result in injury, pain and frustration. Application over these areas may further be uneven or missed entirely. If consumers are unsuccessful at evenly or thoroughly applying a lotion product, their skin may be exposed to the environment, leading to burns or excessively dry and itchy skin.

A device is required that resolves the current issues associated with lotion application to all areas of the body, and one that provides such assistance without requiring a third party. The device must be compact and easily portable to allow application in all situations and conditions, and the applicator should be soothing to the touch. Individuals would be apt to leave it behind or simply forget it if not provided in a condensable, transportable form. Likewise, an individual would be more willing to utilize the product if the applicator provides a desirable tactile feeling.

The present invention provides a device that address a need in the art for a portable lotion applicator device with a pleasing applicator. The present invention is a foldable, collapsible device that provides a user with the ability apply lotions without the assistance of others. The applicator is shaped in the form of a human hand, with fingers joined together and a palm positioned to facilitate capturing and spreading of lotion along a user's skin.

2. Description of the Prior Art

Several patents have been issued related to devices that improve application of lotions. These patents each have drawbacks or fail to address all the issues provided for by the present invention.

Several patents have been issued regarding lotion applicators that require wasteful use of pads. Kales U.S. Pat. No. 4,483,356 is directed to a lotion applicator employing a length-adjustable handle into which is inserted a flexible bale with a pad attached thereto which adjustably swivels on the handle so that the flattened pad remains in uniform contact with the user's skin. The applicator is constructed of a soft plastic with a flip-top cap and may serve as an extension of the handle. When the flip-top cap is open and the applicator tilts downwardly, the lotion drips onto the pad. Similarly, Haining U.S. Pat. No. 6,280,108 is directed to a lotion applicator that has a hollow handle for containing lotion. The hollow handle has a closable opening and flexible walls such that the squeezing of the walls forces lotion contained within the hollow handle to exit the closable opening. A casing is attached to the handle and covers the closable opening. A porous pad is attached for absorbing lotion squeezed out of the handle. The user then opens the closable opening and squeezes the handle so that lotion exits the handle and is applied to the pad. The user then reattaches the handle to the casing. Now the user is able to apply lotion to his back and other parts of the body by gripping the handle and rubbing the pad over his body.

The Kales and Haining devices require the use of a replaceable pad for applying lotion, resulting in a waste byproduct that must be discarded after use. This results in excess waste, higher costs and an impact on the environment. The present invention, having an integrated application surface, does not require the use of an extra pad and thus prevents waste, and foregoes the user from having to purchase additional pads for future use. Further, such pads do not have the lifelike feel of the application surface of the present invention, which forms a hand shape comprising a soft material that is pleasant to the touch.

Other prior disclosed devices serve as novelty items or simply attach to the tops of standard lotion bottles. Evans U.S. Pat. No. 4,896,984 is directed to a lotion applicator particularly designed for use in applying body lotions and suntan lotions includes an elongated body formed from a resilient material and configured to simulate a human hand and forearm. An internal passage extends through the body and terminates in a lateral opening in the central palm area of the hand portion of the body. A sponge applicator includes a perforated mounting plate having a peripheral edge portion and removeably received in an undercut groove formed adjacent to the lateral opening. A threaded coupling is provided in the internal passage for connection of the threaded neck of a conventional lotion bottle. The Evans device serves as a massage and lotion applicator and as a novelty item. It is designed to fit atop a standard lotion bottle; however it does not address the need for a device that applies lotion onto areas of the body that are difficult to access by hand. The present invention provides a lotion applicator with an extendable handle, allowing even the most obscure portions of the back and body to receive uniform and complete lotion application.

Several prior patents describe devices with extendable arms for lotion application. Steffen U.S. Pat. No. 5,566,418 is directed to an improved lotion applicator comprising an extendable arm and an applicator member affixed to the extendable arm. An individual can grip the extendable arm opposite from the applicator member, to reach the back and hard to reach areas of the body with the applicator member for applying lotion thereto. Similarly, Pelfrey U.S. Pat. No. 5,664,281 is directed to a suntan lotion applicator comprising a structure for holding a specific amount of suntan lotion poured out from a suntan lotion bottle. A component for grasping extends from the suntan lotion holding structure. The suntan holding structure can be maneuvered to reach hard to access areas of the body of the user to apply the suntan lotion thereto.

The Steffen and Pelfrey patents describe devices with extendable arms for lotion application. However, these devices are not collapsible in a manner suitable for carriage in a small purse or bag. The present invention addresses this need by providing a handle with one or a plurality of hinges, allowing the user to fold the device into a smaller, storable and transportable size. Further, the present invention may include a bag or case, allowing the device to be stored in a purse or other bag without spreading residual lotion into the interior of the bag.

While several related devices have been described in prior art, such devices do not fully address the issues for which the present invention is designed. There is currently a void in the art for an extendable lotion applicator that provides coverage for difficult to reach parts of the body, and on that does not require costly or wasteful pads. The present invention may be folded and stored in a compact, convenient manner, facilitating its regular use, even in travel situations where a user would be less inclined to carry multiple items. It structure substantially diverges in design elements from the prior art, and consequently it is clear that there is a need in the art for an improvement to existing lotion applicator devices. In this regard the instant invention substantially fulfills these needs.

### SUMMARY OF THE INVENTION

In view of the foregoing disadvantages inherent in the known types of lotion applicators now present in the prior art, the present invention provides a new lotion applicator wherein the same can be utilized for providing convenience for the user when applying lotion to the back and locations on the body without doing so by hand, with assistance from another individual or by using disposable pads.

The present invention allows users to easily apply sun block, moisturizing lotion and other similar products to areas of the body that may be difficult to otherwise reach. The device allows a user to spread these products without using their own hands, eliminating residual lotion on the user's hands after application. The device further allows for application of lotion without utilizing a disposable and wasteful pad, which is difficult to properly dispose in all situations and requires replacement pads after use.

The present invention features an extended handle apparatus comprising a foldout applicator portion designed to resemble a human hand. The fingers are joined together or may alternatively be arrangeable into any desired formation. The palm of the hand is smooth for optimal comfort and even spreading and application of the lotion product onto the user's skin. The palm region is also formed to cup a volume of lotion prior to application, preventing excess spillage. Use of this device may allow consumers to access the middle portions of their backs and other hard-to-reach areas without straining their arms or necks. Consumers will further enjoy the convenience provided by the novelty of the device, along with the ornamental design thereof.

It is therefore an object of the present invention to provide a new and improved lotion applicator device that has all of the advantages of the prior art and none of the disadvantages.

Another object of the present invention is to provide a lotion applicator for the purposes of applying lotion onto difficult to reach areas of the body.

Another object of the present invention is to provide a compact, hand-shaped lotion applicator that is comfortable and soft against a user's skin, one that is adapted to cup a volume of lotion prior to application and one that can be adapted to provide a massaging tool for the user.

Another object of the present invention is to provide a lotion applicator device that eliminates the need for a user to spread lotion with his or her own hands.

Another object of the present invention is to provide a lotion applicator device that eliminates any non-reusable or otherwise wasteful pad applicator.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 is a view of the present invention in use, wherein lotion is being applied to the back of a user.

FIG. 2 is a perspective view of the present invention in an unfolded position, working position.

FIG. 3 is a perspective view of the present invention in a folded position, ready for storage or transport.

### DETAILED DESCRIPTION OF THE INVENTION

Reference is made herein to the attached drawings. Like reference numerals are used throughout the drawings to depict like or similar elements of the lotion applicator device. For the purposes of presenting a brief and clear description of the present invention, the preferred embodiments are discussed as used for applying lotion to difficult to reach areas of the body. The illustrations are intended for representative purposes only and should not be considered to be limiting in any respect.

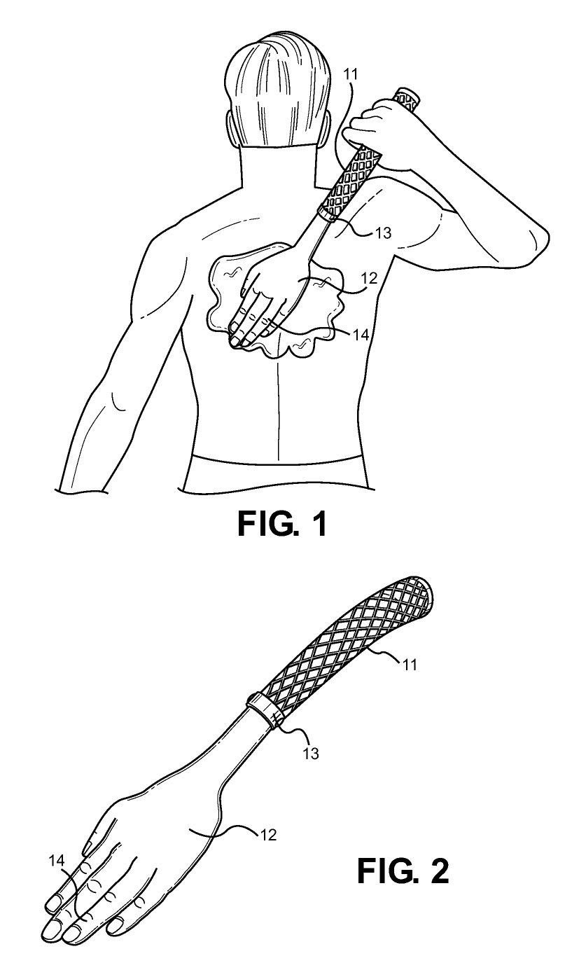

Referring now to FIG. 1, there is shown a perspective view of the present invention in use. Lotion has been dispensed onto the applicator 12 and the handle apparatus 11 is unfolded at a hinge 13, allowing extension of the applicator for use. The user grasps the handle 11 and applies lotion or massages the same into his or her skin along any area of the body. The applicator comprises a soft, hand-shaped device that cups a volume of lotion and acts as a multi-contoured massaging device. The fingers 14 of the applicator 12 may be molded into a static position, or alternatively may allow independent manipulation to place the hand in a specific position during use.

Referring now to FIG. 2, there is shown a perspective view of the present invention in an unfolded, working position. The handle apparatus 11 is extended from the applicator 12, unfolding at a hinge 13 for securement of the device into a working position. Friction within the hinge, or a lock hinge, may provide securement of the device in this position. Lotion is placed either onto the applicator or directly onto a user's body for spreading and massaging the lotion into a user's skin.

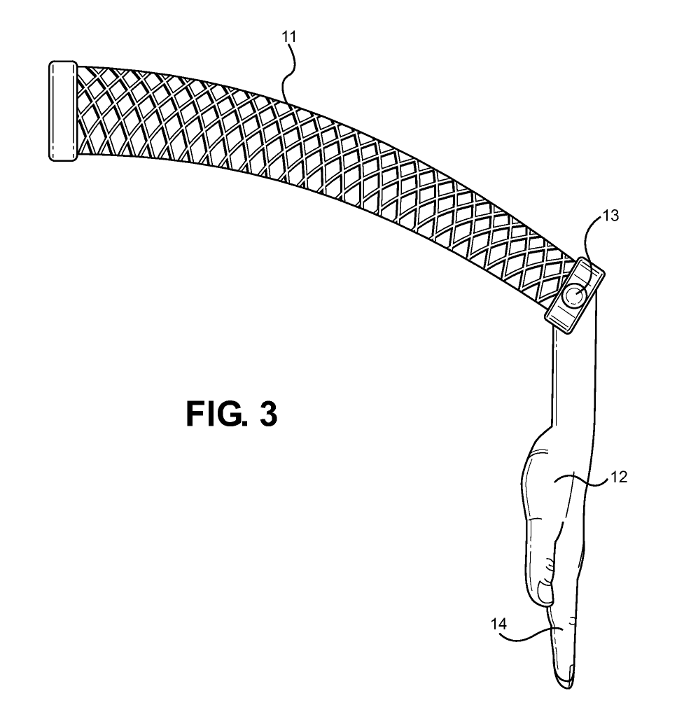

Referring now to FIG. 3, there is shown a perspective view of the present invention in a partially folded state. The applicator 12 is rotated about the hinge mechanism 13, allowing the applicator to collapse into a condensed state for transport and storage. Prior to storage, the applicator 12 has been cleaned of residual lotion, and the fingers 14 have been positioned in a compact manner if a finger-manipulative embodiment is provided. A bag or storage container may be provided to surround the folded device to prevent any residual lotion from spreading or from contaminating the applicator while being stored.

The present invention comprises a handle apparatus 11 containing a fold-out applicator 12. The applicator is attached to the handle via a rotating hinge mechanism 13, allowing it to be rotated into a working position or folded toward the handle 11 in a stowed position. The handle may include one or a plurality of hinges 13, allowing the device to be folded into a compact size convenient for being carried in a purse or small bag. Multiple hinges are contemplated to provide an elongated handle 11 region for further reaching capabilities and improved convenience when applying lotion to difficult regions of the body. The applicator 12 is designed as a life-like representation of a hand, complete with fingers 14, fingernails, skin indentations and wrinkles. The fingers 14 may be joined together or alternatively spread as desired by the user. A preferred embodiment utilizes a molded hand shape that provides a static configuration. An alternate embodiment comprises fingers that are not in connection, allowing independent movement thereof to suit a user's preferences or needs. The palm is smooth and has a lifelike feel for optimal comfort and even application of a product onto the user's skin. This region may be concave in shape, allowing the palm to hold a small reserve of lotion prior to application. The ability to cup a small volume of lotion prevents spillage and wasted lotion during use. The handle 11 may comprise a texture or groove pattern to facilitate improved grip during use, which is particularly useful when spreading lotion or similarly viscous liquid.

Materials contemplated for construction of the device include a plastic handle and a soft, rubber applicator that is flexible to the touch and has no sharp edges. It is not desired to limit the present invention to a specific material type or method of manufacture, but rather it is desired to disclose a configuration that is known to provide a useful applicator device. Any suitable material known to one skilled in the art of lotion applicators that provides the same goal as disclosed herein may be utilized in its construction. The applicator may further be flesh-toned to provide a lifelike appearance.

In use, the present invention allows users to easily apply sun block, moisturizing lotion or any other similar product to areas of the body that are difficult to reach. Users unfold the handle apparatus 11 from the applicator 12 at the hinge 13. The user then dispenses a suitable amount of lotion onto the applicator 12 or onto his or her body. Gripping the handle 11, the user then applies or spreads the lotion as desired, recoating the applicator 12 or area of interest with lotion as needed. The applicator may further be utilized to massage one's back or to scratch a difficult to reach area prior to or during lotion application.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A handheld lotion applicator, comprising:
a handle portion, an applicator region and a hinge mechanism;
said applicator comprising a structure resembling a human hand, with fingers and a palm region;
said handle portion and said applicator region attached via said hinge mechanism, allowing rotation with respect to one another to provide an extended, working position or a folded, stowed position;
said handheld portion further comprising a cupped palm region adapted for holding a volume of lotion.

2) A device as in claim 1, wherein said handle portion comprises an outer surface of grooves for improved grip.

3) A device as in claim 1, wherein said hinge mechanism further comprises a locking mechanism that secures the device in a working position.

4) A device as in claim 1, wherein said handle portion comprises individually separable fingers that are positionable based on user preferences.

5) A device as in claim 1, wherein said handle portion comprises a molded, static position wherein said fingers are secured together.

6) A device as in claim 1, further comprising a second hinge mechanism along said handle portion to provide an elongated handle region and compact, stowed position.

7) A handheld lotion applicator, comprising:
a handle portion, an applicator region and a plurality of hinge mechanisms;
said applicator comprising a structure resembling a human hand, with fingers and a palm region;
said handle portion and said applicator region attached via said hinge mechanism, allowing rotation with respect to one another to provide an extended, working position or a folded, stowed position;
said handle portion further comprises a hinge mechanism along its length to provide an elongated handle region and compact, stowed position;
said handheld portion further comprising a cupped palm region adapted for holding a volume of lotion.

8) A device as in claim 7, wherein said handle portion comprises an outer surface of grooves for improved grip.

9) A device as in claim 7, wherein said hinge mechanism further comprises a locking mechanism that secures the device in a working position.

10) A device as in claim 7, wherein said handle portion comprises individually separable fingers that are positionable based on user preferences.

11) A device as in claim 7, wherein said handle portion comprises a molded, static position wherein said fingers are secured together.
